(19) United States
(12) Patent Application Publication
(10) Pub. No.: US 2002/0167143 A1
(43) Pub. Date: Nov. 14, 2002

(54) Folding structure for kick scooter

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/850,151

(22) Filed: May 8, 2001

(51) Int. Cl. B62M 1/00

(52) U.S. Cl. 280/87.041; 280/87.021

(57) ABSTRACT

A folding structure includes a mounting base fixedly fastened to the footplate of a kick scooter, the mounting base having a first locating hole and a second locating hole, a coupling member fixedly connected to a steering control handle and pivoted to the mounting base for enabling the steering control handle to be turned between the operative position and the non-operative position, a stop member mounted in the coupling member, a pusher mounted in the stop member and adapted to force the stop member into engagement with one of the first locating hole and second locating hole of the mounting base to further lock the steering control handle in the operative or non-operative position, an actuating member adapted to move the stop member into the inside of the coupling member away from the mounting base for enabling the steering control handle to be turned with the coupling member between the operative position and the non-operative position.

### BACKGROUND OF THE INVENTION

The present invention relates to kick scooters and, more specifically, to a folding structure for kick scooter.

A conventional kick scooter is generally comprised of a footplate equipped with front and rear wheels, and a steering control handle fixedly connected to the front side of the footplate in vertical. Because the steering control handle is not folding collapsible, the kick scooter occupies much storage space when not in use. Nowadays, various folding collapsible kick scooters have been disclosed, and have appeared on the market. However these folding collapsible kick scooters are commonly complicated, and tend to be forced out of the locking position accidentally. Therefore, conventional folding collapsible kick scooters are not safe in use.

### SUMMARY OF THE INVENTION

The present invention has been accomplished to provide a folding structure for kick scooter, which eliminates the aforesaid drawbacks. It is one object of the present invention to provide a folding structure for kick scooter, which is easy to operate. It is another object of the present invention to provide a folding structure for kick scooter, which positively locks the kick scooter between the operative position and the non-operative position. To achieve these and other objects of the present invention and according to one aspect of the present invention, the folding structure comprises a mounting base fixedly fastened to the footplate of the kick scooter, the mounting base comprising a first locating hole and a second locating hole, a coupling member fixedly connected to the steering control handle of the kick scooter and pivoted to the mounting base for enabling the steering control handle of the kick scooter to be turned between the operative position and the non-operative position, the coupling member comprising an axial hole, which is aimed at the first locating hole of the mounting base when the steering control handle of the kick scooter is turned to the operative position, or aimed at the second locating hole of the mounting base when the steering control handle of the kick scooter is turned to the non-operative position, a stop member mounted in the axial hole of the coupling member, a pusher mounted in the axial hole of the stop member and adapted to push the stop member out of the axial hole of the coupling member into engagement with one of the first locating hole and second locating hole of the mounting base, and an actuating member adapted to move the stop member into the inside of the axial hole of the coupling member away from the mounting base for enabling the steering control handle of the kick scooter to be turned with the coupling member between the operative position and the non-operative position.

### BRIEF DESCRIPTION OF THE DRAWINGS

FIG. 1 is an elevational view of a folding structure for kick scooter according to the present invention.

FIG. 2 is a sectional assembly view of the folding structure for kick scooter according to the present invention.

FIG. 3 is a side view of FIG. 3.

FIG. 4 is similar to FIG. 3 but showing the stop member lifted with the actuating member and disengaged from the first recessed locating hole of the rectangular top block of the mounting base.

FIG. 5 is similar to FIG. 4 but showing the handle turned backwardly downwards with the coupling member relative to the mounting base.

FIG. 6 shows the handle turned to the non-operative position, the stop member engaged into the second recessed locating hole of the rectangular top block of the mounting base.

### DETAILED DESCRIPTION OF THE PREFERRED EMBODIMENT

Referring to FIGS. from 1 through 3, a folding structure for kick scooter is used in a kick scooter and coupled between the footplate A and steering control handle B of the kick scooter, for enabling the steering control handle B to be turned relative to the footplate A between the operative position and the non-operative position. The folding structure comprises a mounting base 10, a coupling member 20, a stop member 30, a pusher 40, and an actuating member 50.

The mounting base 10 comprises a bottom shaft 11 fixedly fastened to the front side of the footplate A adjacent to the front wheels of the kick scooter, and a rectangular top block 12 pivoted to the coupling member 20. The rectangular top block 12 comprises a smoothly arched top face 13 adapted to guide movement of the coupling member 20 with the steering control handle B between the operative position and the non-operative position, a first recessed locating hole 14 and a second recessed locating hole 15 at two sides of the smoothly arched top face 13, and a pivot hole 16 horizontally extended through two sides thereof.

The coupling member 20 comprises a cylindrical body 24 connected to the bottom end of the steering control handle B, an axial hole 25 axially extended to the bottom sidewall of the cylindrical body 24, an oblong sliding slot 26 transversely extended through the cylindrical body 24 across the axial hole 25, two bottom lugs 21 bilaterally disposed at the bottom side, the bottom lugs 21 each having a horizontal pivot hole 23, a bottom coupling hole 22 defined between the bottom lugs 21 in communication with the axial hole 25 of the cylindrical body 24 and coupled to the rectangular top block 12 of the mounting base 10, and a pivot bolt 60 fastened to the pivot hole 23 of each of the bottom lugs 21 and the pivot hole 16 of the rectangular top block 12 to pivotally secure the coupling member 20 to the rectangular top block 12 of the mounting base 10.

The stop member 30 is a cylindrical rod member mounted in the axial hole 25 of the coupling member 20 and moved to selectively engage the first recessed locating hole 14 or second recessed locating hole 15 of the mounting base 10, having a transversely extended round hole 31 in the middle.

The pusher 40 is a spring (or elastic) member mounted in the axial hole 25 of the cylindrical body 24 and stopped against one end, namely, the top end of the stop member 30. The pusher 40 imparts a downward pressure to the stop member 30, forcing the stop member 30 into engagement with the first recessed locating hole 14 or second recessed locating hole 15 of the mounting base 10, so as to lock the coupling member 20 and the handle B in the first (operative) position or the second (non-operative) position.

The actuating member 50 is a round rod of diameter fitting the round hole 31 of the stop member 30. The actuating member 50 is inserted through the oblong sliding slot 26 of the coupling member 20 and the round hole 31 of the stop member 30 to secure the stop member 30 to the coupling member 20.

Further, a sleeve 57 is sleeved onto the cylindrical body 24 of the coupling member 20 and fastened to the actuating member 50 for moving by hand to lift the actuating member 50 and the stop member 30 in the oblong sliding slot 26 against the pusher 40. According to the present preferred embodiment. The sleeve 57 has two through holes 58 aligned at two sides through which the actuating member 50 inserted through the oblong sliding slot 26 of the coupling member 20 and the round hole 31 of the stop member 30 to secure the sleeve 57 and the stop member 30 to the coupling member 20. The sleeve 57 has a flanged handhold portion 59 radially protruded from the periphery thereof for the holding of the hand.

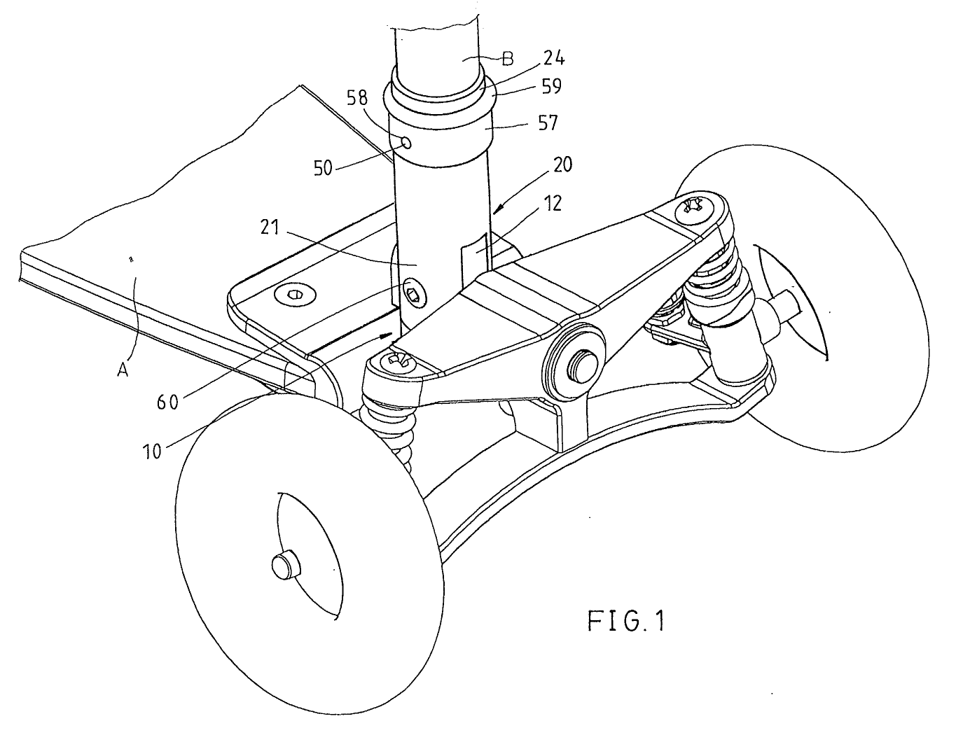

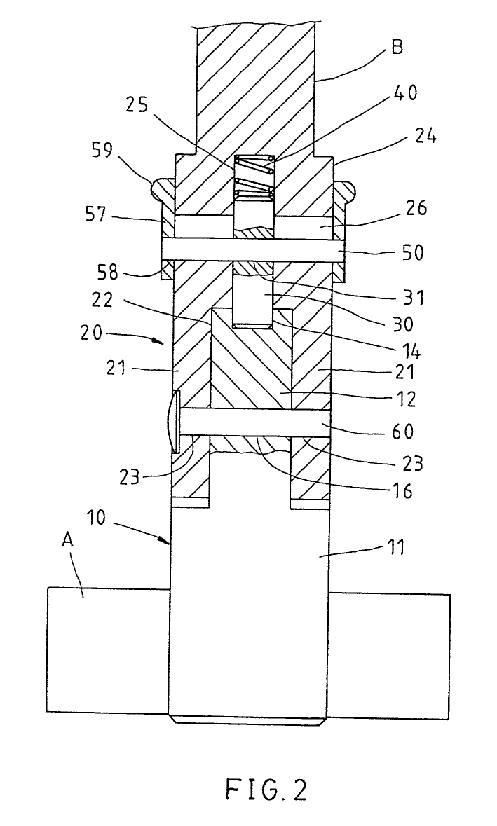

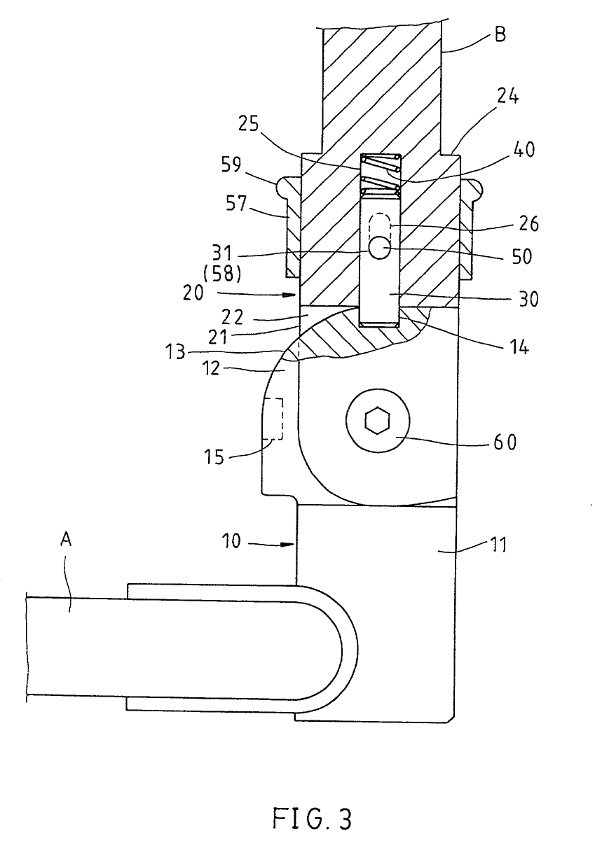

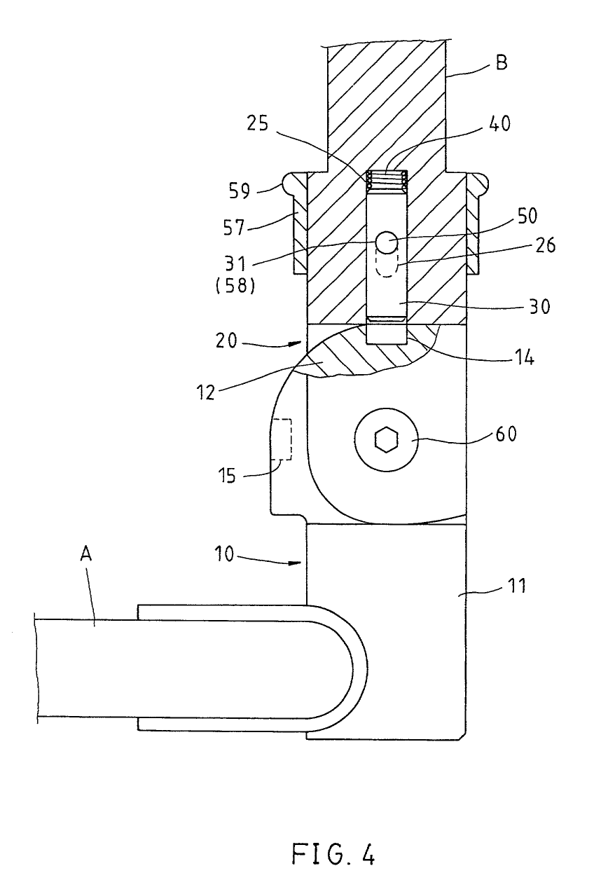

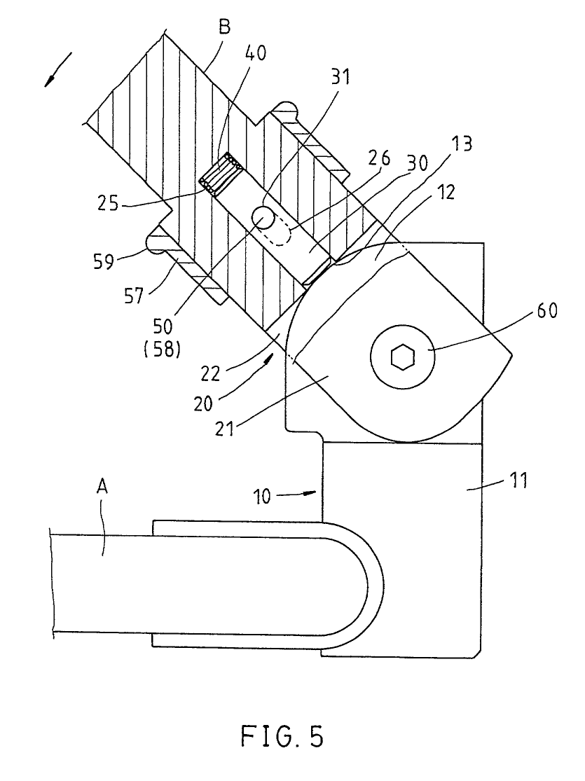

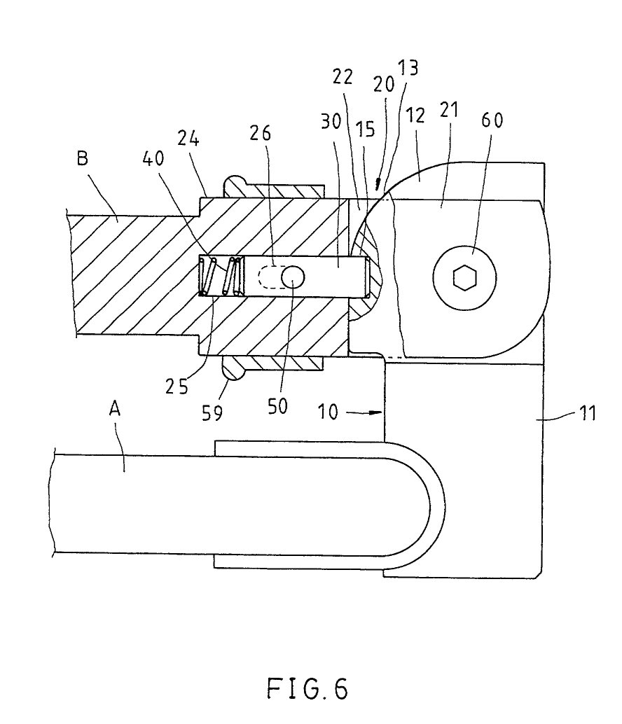

When the handle B is set in the first (operative) position as shown in FIGS. 1, 2 and 3, the stop member 30 is forced by the pusher 40 into engagement with the first recessed locating hole 14 of the rectangular top block 12 of the mounting base 10, and therefore the steering control handle B is locked in the first (operative) position. When not in use, the sleeve 57 is pulled upwards to lift the stop rod 30 from the first recessed locating hole 14 against the pusher 40 (see FIG. 4), for enabling the handle B to be turned downwardly forwards from the first (operative) position to the second (non-operative) position (see FIG. 5). When moved to the second (non-operative) position, the sleeve 57 is released from the hand, and the pusher 40 immediately forces the stop member 30 out of the axial hole 25 into engagement with the second recessed locating hole 15 of the rectangular top block 12 of the mounting base 10 to lock the steering control handle B in the second (non-operative) position (see FIG. 6). When extending out of the handle B, the sleeve 57 is pulled to lift the stop member 30 from the second recessed locating hole 15 of the rectangular top block 12 of the mounting base 10, for enabling the steering control handle B to be turned from the second (non-operative) position to the first (operative) position.

AS indicated above, the folding structure can easily be unlocked simply by pulling the sleeve 57 upwards. When turning the steering control handle B to the operative or non-operative position, the pusher 40 automatically forces the stop member 30 into engagement with the first recessed locating hole 14 or second recessed locating hole 15 to lock the steering control handle B in position.

A prototype of folding structure for kick scooter has been constructed with the features of FIGS. 16. The folding structure for kick scooter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A folding structure coupled between the footplate and steering control handle of a kick scooter for enabling the steering control handle of the kick scooter to be alternatively set between a first position and a second position, the folding structure comprising:
a mounting base fixedly fastened to the footplate of the kick scooter, said mounting base comprising a first locating hole and a second locating hole;
a coupling member fixedly connected to the steering control handle of the kick scooter and pivoted to said mounting base for enabling the steering control handle of the kick scooter to be turned between the first position and the second position, said coupling member comprising an axial hole, which is aimed at said first locating hole of said mounting base when said coupling member is turned with the steering control handle of the kick scooter to the first position, or aimed at said second locating hole of said mounting base when said coupling member is turned with the steering control handle of the kick scooter to the second position;
a stop member mounted in said axial hole of said coupling member;
a pusher mounted in said axial hole of said stop member and adapted to push said stop member out of said axial hole of said coupling member into engagement with one of said first locating hole and said second locating hole of said mounting base; and
an actuating member adapted to move said stop member into the inside of said axial hole of said coupling member away from said mounting base for enabling the steering control handle of the kick scooter to be turned with said coupling member between said first position and said second position.

2. The folding structure of claim 1 wherein said coupling member comprises an oblong sliding slot extended across said axial hole; said actuating member is inserted through said oblong sliding slot of said coupling member and connected to said stop member for moving said stop member in and out of said axial hole, said actuating member having at least one end extended out of said oblong sliding slot for moving by external force.

3. The folding structure of claim 2 further comprising a sleeve sleeved onto said coupling member and fastened to at least one end of said actuating member for operation by hand to move said actuating member in said oblong sliding slot.

4. The folding structure of claim 3 wherein said sleeve has a flanged handhold portion for the holding of the hand.

5. The folding structure of claim 4 said flanged handhold portion is radially protruded from the periphery of said sleeve.

6. The folding structure of claim 1 wherein said pusher is an elastic member.

7. The folding structure of claim 1 wherein said stop member is a cylindrical rod member having a transverse round hole to which said actuating member is fastened.

8. The folding structure of claim 1 wherein said pusher is a spring member.
